(19) United States
(12) Patent Application Publication
(10) Pub. No.: US 2018/0093348 A1
(43) Pub. Date: Apr. 5, 2018

(54) LASER BEAM MACHINE, MACHINING FACILITY, SETTING APPARATUS, PROGRAM AND SETTING METHOD

(71) Applicant: Mitsubishi Electric Corporation, Tokyo (JP)

(72) Inventors: Toshiki KOSHIMAE, Tokyo (JP); Hiroko TAKADA, Tokyo (JP); Takanori MIYAZAKI, Tokyo (JP); Hibiki YAMAMOTO, Tokyo (JP)

(73) Assignee: Mitsubishi Electric Corporation, Tokyo (JP)

(21) Appl. No.: 15/323,767

(22) PCT Filed: Mar. 25, 2016
(86) PCT No.: PCT/JP2016/059719

§ 371 Date: Jan. 4, 2017

(51) Int. Cl. B23K 26/08; B23K 26/38; B23K 37/04

(52) U.S. Cl. CPC B23K 26/08; B23K 37/04; B23K 26/38

(57) ABSTRACT

A laser beam machine cuts a workpiece into a plurality of parts and a remainder material. The machine includes a workpiece supporting unit including supports arranged at intervals and supporting the workpiece and a machining head radiating a laser beam to the workpiece. The machine includes a relative movement unit relatively moving the machining head and the workpiece supporting unit and a control apparatus controlling the relative movement unit and the machining head to cut the workpiece. The control apparatus forms, when cutting the workpiece, joints for coupling, to a partial remainder material that is a portion of the remainder material, both of a part that drops off from the supports after cutting and a part that cannot be attracted by the conveying and attracting unit after cutting such that the partial remainder material and the part are restricted from dropping from the supports and are attractable by the conveying and attracting unit.

### FIELD

The present invention relates to a laser beam machine, a machining facility, a setting apparatus, a program, and a setting method for cutting a workpiece to make a component part and a remainder material.

### BACKGROUND

A laser beam machine radiates a laser beam to a workpiece and forms a cutting line on the workpiece in a state in which the workpiece is supported on a plurality of supports, and cuts the workpiece into component parts and a remainder material (see Patent Literature 1).

The supporting units of the laser beam machine disclosed in Patent Literature 1 are disposed at intervals along both of a first direction and a second direction crossing the first direction. Therefore, in order to suppress drop of the parts from the supports after the cutting, the laser beam machine disclosed in Patent Literature 1 forms a joint between a part having a size likely to drop off from the supporting units and the remainder material, or forms a joint for coupling parts having a size likely to drop off from the supporting units, with each other.

### CITATION LIST

### Patent Literature

Patent Literature 1: Japanese Patent Application Laid-Open No. 2013-180314

### SUMMARY

### Technical Problem

The parts cut by the laser beam machine disclosed in Patent Literature 1 are attracted and conveyed to a post process by a conveying and attracting unit. When the conveying and attracting unit has an attracting surface for sucking gas between the conveying and attracting unit and the part and attracting the part, it is likely that the entire attracting surface cannot be brought into contact with a surface of the part cut by the laser beam machine disclosed in Patent Literature 1 depending on the size of the part.

When the entire attracting surface cannot be brought into contact with the surface of the part, there is a problem in that the laser beam machine disclosed in Patent Literature 1 continues to suck the gas from a portion of the attracting surface not in contact with the surface of the part, the conveying and attracting unit cannot attract the parts cut from the remainder material, and the conveying and attracting unit cannot convey the parts.

The present invention has been devised in view of the above circumstances, and an object of the present invention is to provide a laser beam machine that can convey parts cut from a remainder material.

### Solution to Problem

To solve the above mentioned problem and achieve the object, the present invention provides a laser beam machine for cutting a workpiece into a plurality of parts and a remainder material. The laser beam machine includes a workpiece supporting unit including a plurality of supporting units that are disposed at intervals and support the workpiece, and a machining head that radiates a laser beam to the workpiece. The laser beam machine includes a relative movement unit that relatively moves the machining head and the workpiece supporting unit, and a control unit that controls the relative movement unit and the machining head to cut the workpiece. The control unit makes control to form, when cutting the workpiece, joints for coupling, to a partial remainder material, which is a portion of a remainder material, at least both of a part that is to drop off from the supports after the cutting and a part that cannot be attracted by a conveying and attracting unit after the cutting from among the parts, and to cut the partial remainder material such that the partial remainder material and the part coupled to the partial remainder material can be restricted from drop-off from the supports and are attracted by the conveying and attracting unit.

### Advantageous Effects of Invention

The laser beam machine according to the present invention has an effect that it is possible to convey the part cut from the remainder material.

### BRIEF DESCRIPTION OF DRAWINGS

FIG. 1 is a diagram showing a configuration of a laser beam machine according to a first embodiment.

FIG. 2 is a plan view of a workpiece supporting unit of the laser beam machine shown in FIG. 1.

FIG. 3 is a sectional view taken along the line III-III of FIG. 2.

FIG. 4 is a perspective view of a main part of the workpiece supporting unit shown in FIG. 2.

FIG. 5 is a plan view of a workpiece cut by the laser beam machine according to the first embodiment.

FIG. 6 is a diagram showing an example of a configuration of hardware of a control apparatus of the laser beam machine according to the first embodiment.

FIG. 7 is a flowchart showing a setting method according to the first embodiment.

FIG. 8 is a plan view of a workpiece cut by a laser beam machine according to a second embodiment.

FIG. 9 is a flowchart showing a setting method according to the second embodiment.

FIG. 10 is a plan view of a workpiece cut by a laser beam machine according to a third embodiment.

FIG. 11 is a plan view of a workpiece cut by a laser beam machine according to a fourth embodiment.

FIG. 12 is a flowchart showing a setting method according to the fourth embodiment.

FIG. 13 is a plan view of a workpiece cut by a laser beam machine according to a fifth embodiment.

### DESCRIPTION OF EMBODIMENTS

Laser beam machines, machining facilities, setting apparatuses, programs and setting methods according to embodiments of the present invention are described below in detail with reference to the drawings. Note that the present invention is not limited by the embodiments.

### First Embodiment

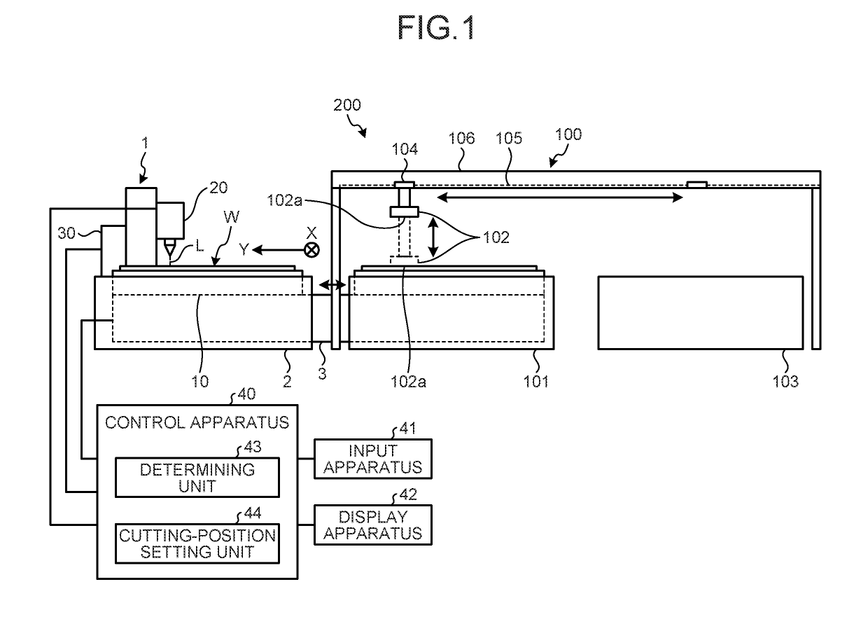

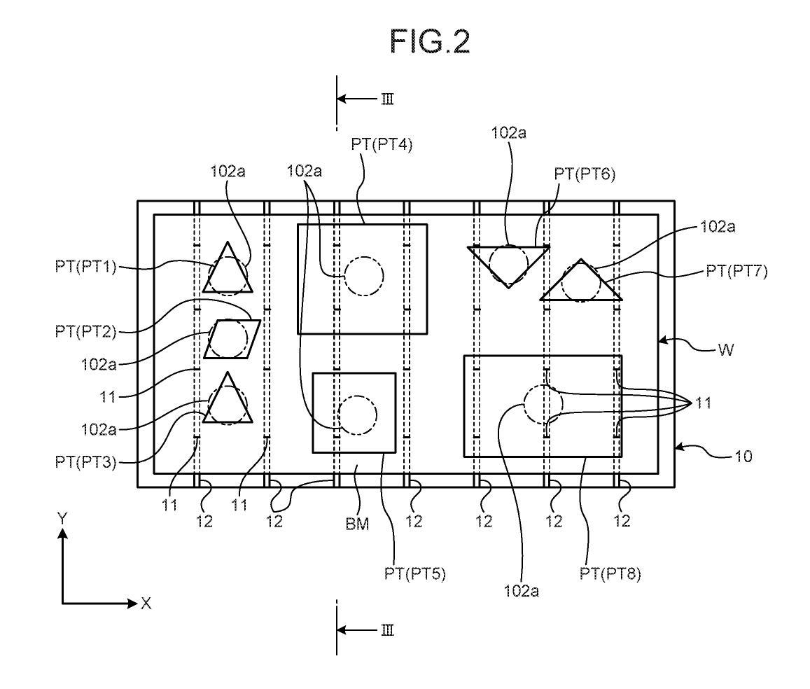

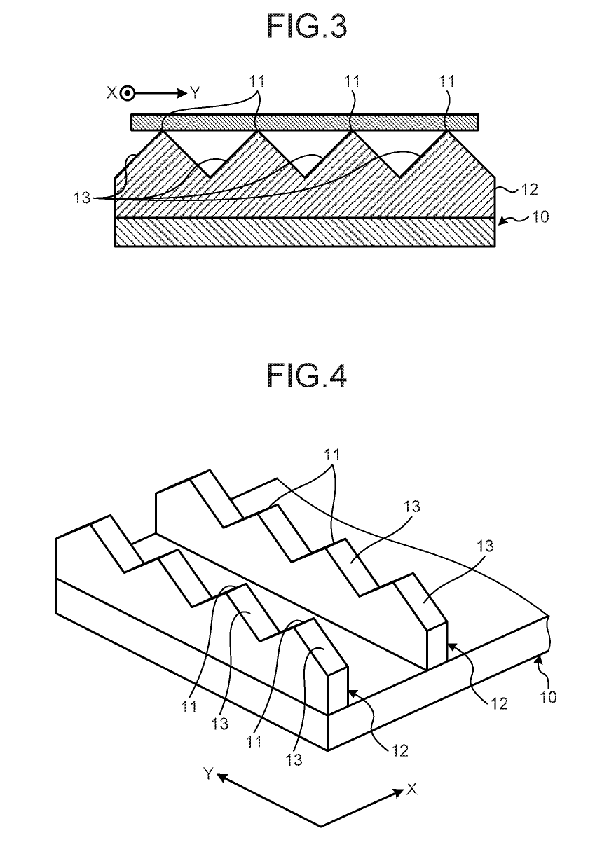

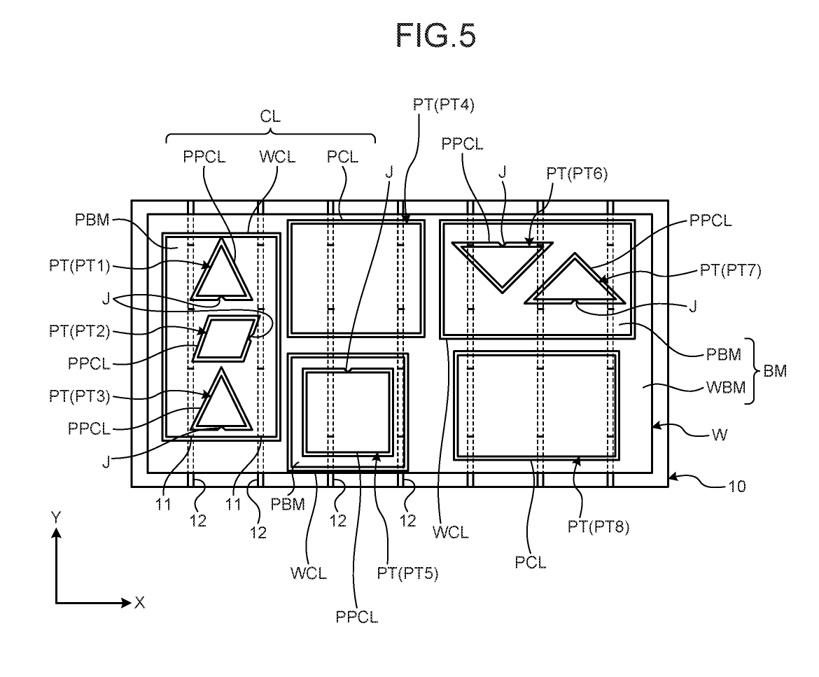

FIG. 1 is a diagram showing a configuration of a laser beam machine according to a first embodiment. FIG. 2 is a plan view of a workpiece supporting unit of the laser beam machine shown in FIG. 1. FIG. 3 is a sectional view taken along the line III-III of FIG. 2. FIG. 4 is a perspective view of a main part of the workpiece supporting unit shown in FIG. 2. FIG. 5 is a plan view of a workpiece cut by the laser beam machine according to the first embodiment.

A laser beam machine 1 shown in FIG. 1 is an apparatus for radiating a laser beam L to a workpiece W and cutting the workpiece W to thereby cut the workpiece W into parts PT and a remainder material BM shown in FIG. 2. In the first embodiment, the workpiece W cut into the parts PT and the remainder material BM by the laser beam machine 1 is made from metal and formed in a flat-plate shape. That is, the workpiece W is a sheet metal. In the first embodiment, a plane shape of the workpiece W is a rectangular shape. The plane shape of the workpiece W is not limited to a rectangular shape and can be a square shape, a pentagonal shape, or other polygonal shapes.

The parts PT are cut from the workpiece W, applied with at least one process from among a bending process, a welding process and a painting process in a post process of the laser beam machine 1, and assembled into a product. The remainder material BM is discarded without being assembled into the product. In the first embodiment, the laser beam machine 1 cuts eight parts PT from the workpiece W. However, the number of the parts PT is not limited to eight. Note that, in this specification, when the parts PT are distinguished from one another, the parts PT are described as a first part PT1, a second part PT2, a third part PT3, a fourth part PT4, a fifth part PT5, a sixth part PT6, a seventh part PT7, and an eighth part PT8. When the parts PT are not distinguished from one another, the parts PT are simply described as parts PT.

The laser beam machine 1 includes, as shown in FIG. 1, a workpiece supporting unit 10 that supports the workpiece W, a machining head 20 that radiates the laser beam L to the workpiece W, a relative movement unit 30 that relatively moves the workpiece supporting unit 10 and the machining head 20, and a control apparatus 40 that is a control unit.

The workpiece W is placed on the workpiece supporting unit 10 which supports the workpiece W. The workpiece supporting unit 10 supports the workpiece W with its posture being parallel to the horizontal direction and suppresses movement of the supported workpiece W. As shown in FIG. 2, a plane shape of the workpiece supporting unit 10 is formed larger than a plane shape of the workpiece W. The workpiece supporting unit 10 includes a plurality of supports 11 disposed at intervals along both of an X direction, which is a first direction, and a Y direction, which is a second direction crossing the X direction. Both of the X direction and the Y direction are parallel to the horizontal direction. In the first embodiment, the X direction and the Y direction are orthogonal to each other. In the first embodiment, the supports 11 are disposed at intervals along both of the X direction and the Y direction orthogonal to each other. However, directions in which the supports 11 are disposed at intervals are not limited to the X direction and the Y direction. In short, in the present invention, a number of supports 11 only have to be disposed at intervals.

The workpiece W is placed on the supports 11, and the supports 11 support the workpiece W. A number of supports 11 are arranged along the horizontal direction. The supports 11 are disposed at equal intervals in the X direction and disposed at equal intervals in the Y direction. The intervals in the X direction of the supports 11 and the intervals in the Y direction of the supports 11 may be equal to each other or may be different from each other. In the first embodiment, as shown in FIGS. 3 and 4, the supports 11 are formed on a plurality of supporting plates 12 provided in a standing position upward from the workpiece supporting unit 10. The supporting plates 12 are in parallel to the Y direction and arranged at equal intervals in the X direction. In the supporting plates 12, a plurality of ridge sections 13 having a ridge shape in section are formed, and peaks of the ridge sections 13 are the supports 11. The peaks of the ridge sections 13, that is, the supports 11 are disposed at equal intervals in the Y direction. The supports 11 may be tips of pins projecting upward from the workpiece supporting unit 10. The shape of the support 11 is not limited to the shape shown in the first embodiment.

The workpiece supporting unit 10 is provided so that the unit 10 can be moved by an inter-apparatus moving unit 3 between an apparatus main body 2 of the laser beam machine 1 and an apparatus main body 101 of a sorting apparatus 100. In the first embodiment, the inter-apparatus moving unit 3 is composed of a motor, a lead screw that moves the workpiece supporting unit 10 based on a rotary drive force of the motor, and a linear guide that makes guidance in a moving direction for the workpiece supporting unit 10. The configuration of the inter-apparatus moving unit 3 is not limited to the configuration formed by the motor, the lead screw and the linear guide.

The sorting apparatus 100 is an apparatus that sorts the parts PT from the workpiece W supported by the workpiece supporting unit 10 and cut by the laser beam machine 1. The sorting apparatus 100 includes the apparatus main body 101, a conveying and attracting unit 102 that attracts the parts PT of the workpiece W supported by the workpiece supporting unit 10 moved to the apparatus main body 101, and a parts storage place 103 where the parts PT are placed. The conveying and attracting unit 102 has an attracting surface 102a that comes into contact with the surface of the part PT and attracts the part PT. In the first embodiment, a plane shape of the attracting surface 102a is a circular shape as indicated by an alternate long and two short dashes line in FIG. 2.

The conveying and attracting unit 102 sucks the outside air from a plurality of holes provided in the attracting surface 102a, and attracts the part PT to the attracting surface 102a with a negative pressure generated by sucking the outside air. Therefore, if the entire attracting surface 102a does not come into contact with the surface of the part PT, the conveying and attracting unit 102 cannot generate the negative pressure between the conveying and attracting unit 102 and the part PT and cannot attract the part PT.

The conveying and attracting unit 102 is provided so that the unit 102 can be lifted and lowered along the vertical direction by a lifting and lowering unit 104. The conveying and attracting unit 102 is lifted and lowered by the lifting and lowering unit 104, so that the unit 102 is moved between a position indicated by a broken line where the conveying and attracting unit 102 is in contact with the part PT of the workpiece W and a conveying position indicated by a solid line above the contact position indicated by the broken line. In the first embodiment, the lifting and lowering unit 104 is provided in an upper supporting unit 106 set above the apparatus main body 101. In the first embodiment, the lifting and lowering unit 104 is configured by an air cylinder that extends and retracts a rod to thereby lift and lower the conveying and attracting unit 102. However, the lifting and lowering unit 104 is not limited to this configuration.

The lifting and lowering unit 104 is provided so that the unit 104 can be moved along at least one of the X direction and the Y direction by a moving unit 105. The moving unit 105 is provided in the upper supporting unit 160. The moving unit 105 is comprised of a motor, a lead screw that moves the workpiece supporting unit 10 based on a rotatory drive force of the motor, and a linear guide that makes guidance in a moving direction for the workpiece supporting unit 10. The configuration of the moving unit 105 is not limited to the configuration based on the motor, the lead screw and the linear guide.

The conveying and attracting unit 102 is lifted and lowered by the lifting and lowering unit 104, and the lifting and lowering unit 104 is moved along both of the X direction and the Y direction by the moving unit 105, whereby the conveying and attracting unit 102 conveys the parts PT from the workpiece supporting unit 10 to the parts storage place 103. The laser beam machine 1 and the sorting apparatus 100 constitute a machining facility 200 that machines the workpiece W.

The machining head 20 radiates the laser beam L to the workpiece W and thereby draws, on the workpiece W, cutting lines CL for cutting the workpiece W. The machining head 20 cuts the workpiece W into the parts PT and the remainder material BM. The relative movement unit 30 relatively moves the machining head 20 and the workpiece supporting unit 10 positioned in the apparatus main body 2 along at least one of the X direction and the Y direction. In the first embodiment, the relative movement unit 30 moves the machining head 20 along at least one of the X direction and the Y direction. However, the relative movement unit 30 may move the workpiece supporting unit 10 along both of the X direction and the Y direction, or may move both of the machining head 20 and the workpiece supporting unit 10 along at least one of the X direction and the Y direction. In the first embodiment, the relative movement unit 30 relatively moves the machining head 20 and the workpiece supporting unit 10 along at least one of the X direction and the Y direction. However, a direction in which the relative movement unit 30 relatively moves the machining head 20 and the workpiece supporting unit 10 is not limited to at least one of the X direction and the Y direction. In short, in the present invention, the relative movement unit 30 only has to relatively move the machining head 20 and the workpiece supporting unit 10. The relative movement unit 30 is composed of a motor, a lead screw that moves the workpiece supporting unit 10 based on a rotatory drive force of the motor, and a linear guide that makes guidance in a moving direction of the workpiece supporting unit 10. The configuration of the relative movement unit 30 is not limited to the configuration based on the motor, the lead screw and the linear guide.

The control apparatus 40 controls the relative movement unit 30 and the machining head 20 to form the cutting lines CL on the workpiece W. An input apparatus 41 that inputs the positions of the parts PT in the workpiece W is connected to the control apparatus 40. A display apparatus 42 that displays the positions of the parts PT in the workpiece W is connected to the control apparatus 40. The control apparatus 40 stores the positions of the parts PT in the workpiece W inputted from the input apparatus 41. The control apparatus 40 includes a determining unit 43 and a cutting-position setting unit 44.

The determining unit 43 determines whether each of the parts PT is a part PT that can be supported on the supports 11 after the cutting. In the first embodiment, a part PT that cannot be supported on the supports 11 after the cutting is a part PT that drops off from the supports 11 after the cutting and a part PT that cannot be attracted by the conveying and attracting unit 102 after the cutting. The part PT that drops off from the supports after the cutting is a part PT supported by one or less support 11 in at least one of the X direction and the Y direction. Specifically, the part PT that drops off from the supports 11 after the cutting is a part PT that is not supported by any of the supports 11 after the cutting and drops down between the supports 11 after the cutting and cannot be attracted by the conveying and attracting unit 102. The part PT that drops off from the supports 11 after the cutting is a part PT that is supported by one support 11 in one of the X direction and the Y direction after the cutting and tilts with respect to the horizontal direction and cannot be attracted by the conveying and attracting unit 102. The part PT that cannot be attracted by the conveying and attracting unit 102 after the cutting is a part PT having a surface with which the entire attracting surface 102a of the conveying and attracting unit 102 cannot be brought into contact. That is, the determining unit 43 determines whether each of the parts PT is one of a part PT that drops off from the supports 11 after the cutting and a part PT that cannot be attracted by the conveying and attracting unit 102 after the cutting.

The part PT that can be supported on the supports 11 after the cutting is a part PT that is restricted from dropping off from the supports 11 after the cutting and is attractable by the conveying and attracting unit 102. The part PT restricted from dropping off from the supports 11 after the cutting is a part PT that is supported by two or more supports 11 in both of the X direction and the Y direction and maintained in a parallel state to the horizontal direction. The part PT that is attractable by the conveying and attracting unit 102 after the cutting is a part PT having a surface with which the entire attracting surface 102a can be brought into contact.

In the first embodiment, the first part PT1, the second part PT2 and the third part PT3 are parts PT that are not supported by any one of the supports 11 after the cutting and drop down to between the supports 11. The fifth part PT5, the sixth part PT6 and the seventh part PT7 are parts PT that are supported by one support 11 in one of the X direction and the Y direction and tilt with respect to the horizontal direction after the cutting. The first part PT1, the second part PT2, the third part PT3, the sixth part PT6 and the seventh part PT7 are parts PT having surfaces with which the entire attracting surface 102a of the conveying and attracting unit 102 cannot be brought into contact after the cutting. The fifth part PT5 is a part PT that can be attracted by the conveying and attracting unit 102 after the cutting. The fourth part PT4 and the eighth part PT8 are parts PT that are supported by two or more supports 11 in both of the X direction and the Y direction and can be attracted by the conveying and attracting unit 102.

The cutting-position setting unit 44 is configured to form a joint J for coupling either of the part PT that drops off from the supports 11 after the cutting and the part PT that cannot be attracted by the conveying and attracting unit 102 after the cutting to a partial remainder material PBM shown in FIG. 5, which is a portion of the remainder material BM, and set a position of the cutting line CL such that the partial remainder material PBM and the parts PT coupled to the partial remainder material PBM are restricted from dropping off from the supports 11 and are attractable by the conveying and attracting unit 102. The restriction of the partial remainder material PBM and the parts PT coupled to the partial remainder material PBM from dropping off from the supports 11 means that the partial remainder material PBM and the parts PT coupled by the joint J are supported by the supports 11 in the parallel state to the horizontal direction. The partial remainder material PBM and the parts PT coupled to the partial remainder material PBM being attractable by the conveying and attracting unit 102 means that the entire attracting surface 102a of the conveying and attracting unit 102 can be brought into contact with a surface of at least one of the partial remainder material PBM and the parts PT coupled by the joints J. The joints J are formed of the metal forming the workpiece W and couple the parts PT and the partial remainder materials PBM. The joints J are formed when the laser beam L is not radiated to a part of the workpiece W. That is, the joints J are places that are not cut by the laser beam L. Note that, in FIG. 5, the size of the joint J is exaggerated to be larger than its actual size and shown as triangles.

The partial remainder materials PBM are restricted from dropping off from the supports 11 after the cutting, that is, maintained in parallel to the horizontal direction even after the cutting. The partial remainder materials PBM coupled to the first part PT1, the second part PT2, the third part PT3, the sixth part PT6, and the seventh part PT7, which are parts PT having their surfaces with which the entire attracting surface 102a of the conveying and attracting unit 102 cannot be brought into contact after the cutting, can be attracted by the conveying and attracting unit 102. In the first embodiment, after the cutting, the entire attracting surface 102a of the conveying and attracting unit 102 cannot be brought into contact with the surface of the partial remainder material PBM coupled to the fifth part PT5, which is a part PT that can be attracted by the conveying and attracting unit 102 after the cutting. Therefore, when the fifth part PT5 is to be conveyed, the conveying and attracting unit 102 brings the entire attracting surface 102a into contact with the surface of the fifth part PT5. When forming the cutting lines CL on the workpiece W, the control apparatus 40 forms the joints J for coupling the parts PT that cannot be supported on the supports 11 after the cutting to the partial remainder materials PBM, which are portions of the remainder material BM.

In the first embodiment, the partial remainder material PBM surrounds the outer sides of the parts PT coupled thereto by the joints J. However, the shape of the partial remainder materials PBM is not limited to a shape surrounding the outer sides of the parts PT. In the first embodiment, three partial remainder materials PBM are formed. One partial remainder material PBM is coupled to each of the first part PT1, the second part PT2, and the third part PT3 by the joint J. Another partial remainder material PBM is coupled to the fifth part PT5 by the joint J. The other one partial remainder material PBM is coupled to each of the sixth part PT6 and the seventh part PT7 by the joint J. In this way, the control apparatus 40 also serves as a setting apparatus that sets the positions of the cutting lines CL for cutting the workpiece W of the laser beam machine 1 into a number of parts PT and the remainder material BM.

In this way, when all the cutting lines CL are formed on the workpiece W, as shown in FIG. 5, the remainder material BM is cut into the partial remainder materials PBM and a waste remainder material WBM having been obtained by cutting both of all of the parts PT and the partial remainder materials PBM. The waste remainder material WBM is separated from both of all of the parts PT and the partial remainder materials PBM. When all the cutting lines CL are drawn on the workpiece W, waste cutting lines WCL for cutting off the partial remainder materials PBM and the waste remainder material WBM are formed as cutting lines CL on the workpiece W. The waste cutting lines WCL cut off the partial remainder materials PBM and the waste remainder material WBM over the entire length of the waste cutting lines WCL. When all the cutting lines CL are formed on the workpiece W, part cutting lines PCL for cutting the parts PT that can be supported on the supports 11 after the cutting and the waste remainder material WBM are formed as cutting lines CL. The part cutting line PCL is formed along the outer shape of the parts PT and is made to cut the part PT and the waste remainder material WBM along the entire length of the part cutting line PCL. When all the cutting lines CL are formed on the workpiece W, partial part cutting lines PPCL for cutting the parts PT that cannot be supported on the supports 11 after the cutting and the partial remainder materials PBM are formed as cutting lines CL on the workpiece W. The partial part cutting line PPCL is formed along the outer shape of the part PT and is made to cut the part PT and the partial remainder material PBM except for the joint J.

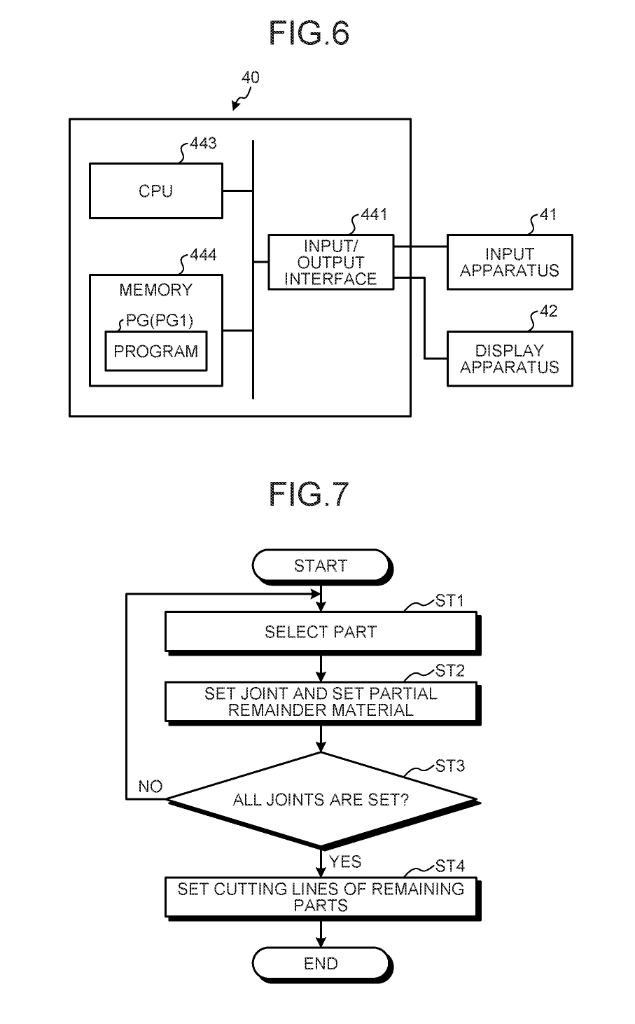

FIG. 6 is a diagram showing an example of the configuration of hardware of the control apparatus of the laser beam machine according to the first embodiment. The control apparatus 40 receives positions of the parts PT with respect to the workpiece W as input from the input apparatus 41 connected to an input/output interface 441 shown in FIG. 6. The input apparatus 41 is configured by a touch panel, a keyboard, a mouse, a trackball or a combination of the foregoing. The control apparatus 40 causes the display apparatus 42 connected to the input/output interface 441 to display the positions of the parts PT with respect to the workpiece W. In the first embodiment, the display apparatus 42 is a liquid crystal display device but is not limited to the liquid crystal display.

As shown in FIG. 6, the control apparatus 40 is a computer including a CPU (Central Processing Unit) 443, a memory 444, and the input/output interface 441. The memory 444 stores software, firmware, or a combination of software and firmware as a program PG. The program PG stored in the memory 444 includes a program PG1 for setting the positions of the cutting lines CL for cutting the workpiece W for the laser beam machine 1 into a number of parts PT and the remainder material BM. The memory 444 stores the positions of the parts PT with respect to the workpiece W inputted from the input apparatus 41. The memory 444 is configured based on a nonvolatile or volatile semiconductor memory, a magnetic disk, an optical disk, or a magneto-optical disk. As the nonvolatile or volatile semiconductor memory, a RAM (Random Access Memory), a ROM (Read Only Memory), a flash memory, an EPROM (Erasable Programmable Read Only Memory), or an EEPROM (Electrically Erasable Programmable Read-Only Memory) is used. In the control apparatus 40, the CPU 443 executes the program PG stored in the memory 444 to realize functions of the determining unit 43 and the cutting-position setting unit 44.

Next, description is given for a method in which the control apparatus 40 sets the positions of the cutting lines CL, that is, a setting method for setting a position of a cutting line CL for cutting the workpiece W for the laser beam machine 1 into a number of parts PT and the remainder material BM. FIG. 7 is a flowchart showing a setting method according to the first embodiment. The setting method according to the first embodiment is executed when the positions of the parts PT with respect to the workpiece W are inputted to the control apparatus 40 from the input apparatus 41 and the control apparatus 40 stores the inputted positions of the parts PT with respect to the workpiece W.

The control apparatus 40 selects one part PT that cannot be supported by the supports 11 after the cutting from among the parts PT (step ST1). The control apparatus 40 sets the joint J, the partial remainder material PBM, and the cutting lines PCL, WCL and PPCL appropriate for the part PL selected at step ST1 (step ST2). The control apparatus 40 determines whether the joints J, the partial remainder materials PBM, and the cutting lines PCL, WCL and PPCL appropriate for all the parts PT that cannot be supported by the supports 11 after the cutting among the parts PT have been set (step ST3). When determining that the joints J, the partial remainder materials PBM, and the cutting lines PCL, WCL and PPCL appropriate for all the parts PT that cannot be supported by the supports 11 after the cutting among the parts PT have not been set (No at step ST3), the control apparatus 40 returns to step ST1.

At step ST1, the control apparatus 40 selects one part PT that cannot be supported by the supports 11 after the next cutting. At step ST2, the control apparatus 40 sets the joint J, the partial remainder material PBM, and the cutting lines PCL, WCL and PPCL appropriate for the selected part PT. When the partial remainder material PBM set at step ST2 at least partially overlaps the partial remainder material PBM set in the past, the control apparatus 40 groups the parts PT, the partial remainder materials PBM of which overlap each other, into one group, and sets the joints J, one partial remainder material PBM corresponding to the grouped parts PT as one group, and the cutting lines PCL, WCL and PPCL appropriate for the parts PT.

When determining that the joints J, the partial remainder materials PBM, and the cutting lines PCL, WCL and PPCL appropriate for all the parts PT that cannot be supported by the supports 11 after the cutting among the parts PT have been set (Yes at step ST3), the control apparatus 40 sets the part cutting lines PCL appropriate for the parts PT that can be supported by the supports 11 after the cutting (step ST4), and ends the setting method of the flowchart shown in FIG. 7. When the partial remainder material PBM set at step ST2 at least partially overlaps the partial remainder material PBM set in the past, the control apparatus 40 groups a number of parts PT, the partial remainder materials PBM of which overlap one another, into one group, and sets the joints J, one partial remainder material PBM corresponding to the parts PT grouped as one group, and the cutting lines PCL, WCL and PPCL appropriate for the parts PT. In this processing, in the first embodiment, as shown in FIG. 5, the first part PT1, the second part PT2 and the third part PT3 are coupled to the same partial remainder material PBM via the joints J. In the first embodiment, as shown in FIG. 5, the fifth part PT5 is coupled to the partial remainder material PBM via the joint J. In the first embodiment, as shown in FIG. 5, the sixth part PT6 and the seventh part PT7 are coupled to the same partial remainder material PBM via the joints J.

Note that, at step ST1, a part PT that cannot be supported by the supports 11 after the cutting is selected from among the parts PT. Therefore, step ST1 is equivalent to a determining step for determining whether the parts PT are one of the part PT that drops off from the supports 11 after the cutting and the part PT that cannot be attracted by the conveying and attracting unit 102 after the cutting. At step ST2, the joint J, the partial remainder material PBM, and the cutting lines PCL, WCL and PPCL appropriate for the part PT that cannot be supported by the supports 11 after the cutting are set. Therefore, step ST2 is equivalent to a cutting-position setting step for forming the joints J for coupling both of the part PT that drops off from the supports 11 after the cutting and the part PT that cannot be attracted by the conveying and attracting unit 102 to the partial remainder material PBM, and setting the positions of the cutting lines CL such that the partial remainder material PBM and the parts PT coupled to the partial remainder material PBM are restricted from dropping off from the supports 11 and can be attracted by the conveying and attracting unit 102. The program PG1 is a program for causing the control apparatus 40 that is a computer, to execute step ST1 and step ST2. The setting method includes step ST1 and step ST2.

In the laser beam machine 1 according to the first embodiment, after the setting method ends, when the workpiece W is carried into the workpiece supporting unit 10 and a machining start command is inputted from the input apparatus 41, the control apparatus 40 radiates the laser beam L to the workpiece W along the set cutting lines PCL, WCL and PPCL and forms the cutting lines PCL, WCL and PPCL on the workpiece W. Therefore, when forming the cutting lines CL on the workpiece W, the control apparatus 40 of the laser beam machine 1 forms the joints J for coupling both of the part PT that drops off from the supports 11 after the cutting and the part PT that cannot be attracted by the conveying and attracting unit 102 after the cutting to the partial remainder material PBM, and cuts the partial remainder material PBM such that the partial remainder material PBM and the parts PT coupled to the partial remainder material PBM are restricted from dropping off from the supports 11 and can be attracted by the conveying and attracting unit 102.

The workpiece W, on which the cutting lines CL are formed, is conveyed to the apparatus main body 101 of the sorting apparatus 100 by the inter-apparatus moving unit 3 while being supported by workpiece supporting unit 10. The sorting apparatus 100 conveys the parts PT to the parts storage place 103 using the conveying and attracting unit 102, and removes the remainder material BM from the workpiece supporting unit 10. The workpiece supporting unit 10 is moved to the laser beam machine 1 again. After a workpiece W is carried in, the workpiece supporting unit 10 forms the cutting lines CL on the workpiece W as described above.

According to the laser beam machine 1, the control apparatus 40 and the setting method of the first embodiment, when forming the cutting lines CL on the workpiece W, the control apparatus 40 forms the joints J for coupling both of the part PT that drops off from the supports 11 after the cutting and the part PT that cannot be attracted by the conveying and attracting unit 102 after the cutting to the partial remainder material PBM. Therefore, in the laser beam machine 1, the control apparatus 40 and the setting method, both of the part PT that drops off from the supports 11 after the cutting and the part PT that cannot be attracted by the conveying and attracting unit 102 after the cutting can be supported on the supports 11 by virtue of the partial remainder material PBM. As a result, in the laser beam machine 1, the control apparatus 40 and the setting method, by the conveying and attracting unit 102 attracting the partial remainder material PBM, it is possible to convey both of the part PT that drops off from the supports 11 after the cutting and the part PT that cannot be attracted by the conveying and attracting unit 102 after the cutting to the parts storage place 103.

### Second Embodiment

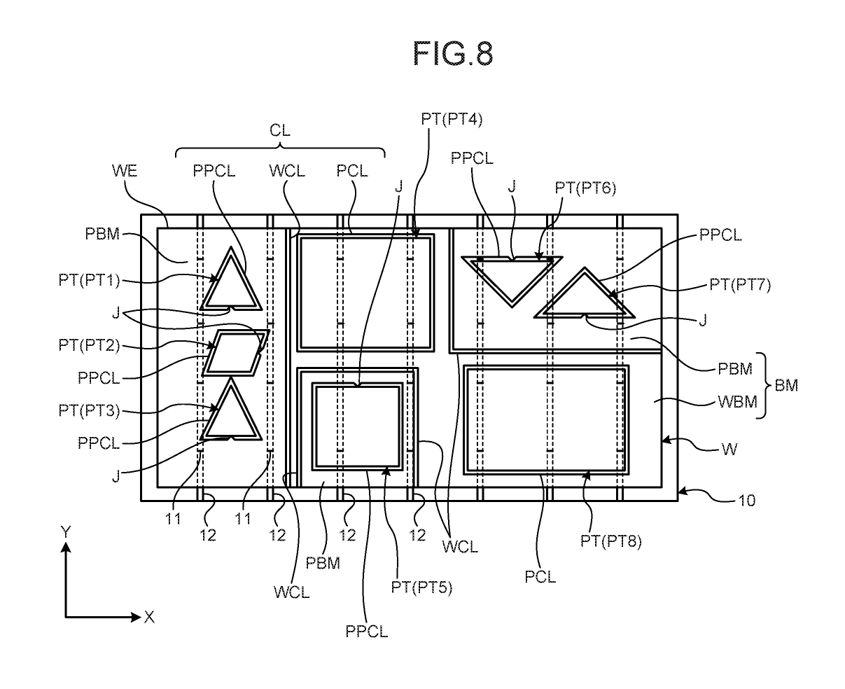

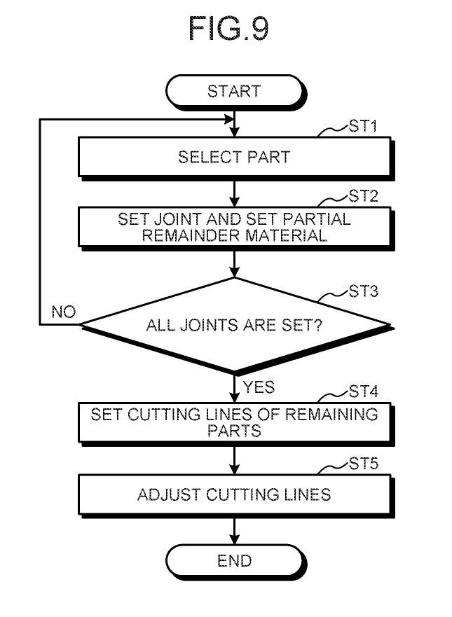

The laser beam machine 1 according to a second embodiment of the present invention is explained with reference to the drawings. FIG. 8 is a plan view of a workpiece cut by the laser beam machine according to the second embodiment. FIG. 9 is a flowchart showing a setting method according to the second embodiment. In FIGS. 8 and 9, elements identical with those in the first embodiment are denoted by the same reference numerals and signs and explanation thereof is omitted.

On the workpiece W to be cut by the laser beam machine 1 according to the second embodiment, as shown in FIG. 8, the waste cutting lines WCL are formed with reaching an outer edge WE of the workpiece W. That is, in the setting method according to the second embodiment, the waste cutting lines WCL are set to reach the outer edge WE of the workpiece W, and the control apparatus 40 forms the waste cutting lines WCL with reaching the outer edge WE of the workpiece W. The laser beam machine 1, the control apparatus 40 and the setting method according to the second embodiment are the same as in the first embodiment except that the positions of the waste cutting lines WCL are different from those in the first embodiment.

In the setting method according to the second embodiment, the control apparatus 40 sets the part cutting lines PCL that can be supported by the supports 11 after the cutting (step ST4) and thereafter adjusts the waste cutting lines WCL (step ST5). In the setting method according to the second embodiment, as shown in FIG. 8, the control apparatus 40 erases the setting of a waste cutting line WCL parallel to the closest outer edge WE of the workpiece W among the waste cutting lines WCL set at step ST2. As shown in FIG. 8, the control apparatus 40 extends the waste cutting lines WCL remaining set to the outer edge WE closest to the waste cutting lines WCL remaining set.

According to the laser beam machine 1, the control apparatus 40 and the setting method of the second embodiment, the joint J for coupling either of the part PT that drops off from the supports 11 after the cutting and the part PT that cannot be attracted by the conveying and attracting unit 102 after the cutting to the partial remainder material PBM is formed. Therefore, as with the first embodiment, it is possible to convey both of the part PT that drops off from the supports 11 after the cutting and the part PT that cannot be attracted by the conveying and attracting unit 102 after the cutting to the parts storage place 103.

According to the laser beam machine 1, the control apparatus 40 and the setting method of the second embodiment, a waste cutting line WCL is formed with reaching the outer edge WE of the workpiece W and the setting of a part of the waste cutting lines WCL set at step ST2 is erased. Therefore, it is possible to reduce a time required for the machining.

### Third Embodiment

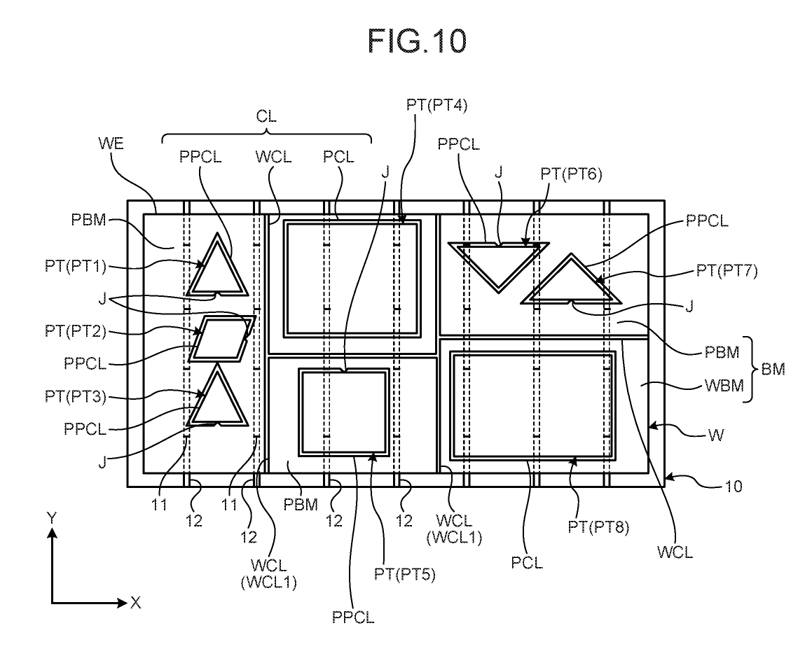

The laser beam machine 1 according to a third embodiment of the present invention is explained with reference to the drawings. FIG. 10 is a plan view of a workpiece cut by the laser beam machine according to the third embodiment. In FIG. 10, elements identical with those in the first and second embodiments are denoted by the same reference numerals and signs, and explanation thereof is omitted.

On the workpiece W cut by the laser beam machine 1 according to the third embodiment, as shown in FIG. 10, some of the waste cutting lines WCL are formed with reaching the outer edge WE of the workpiece W. In addition, some of the waste cutting lines WCL are formed between partial remainder materials PBM adjacent to one another. The laser beam machine 1, the control apparatus 40 and the setting method according to the third embodiment are the same as those in the first and second embodiments except that the positions of the waste cutting lines WCL are different from those in the first and second embodiments.

In the setting method according to the third embodiment, when adjusting the waste cutting lines WCL (step ST5), as with the second embodiment, the control apparatus 40 erases the setting of the waste cutting line WCL parallel to the closest outer edge WE of the workpiece W among the waste cutting lines WCL set at step ST2, and extends the waste cutting line WCL remaining set to the outer edge WE closest to the waste cutting line WCL remaining set. Further, the control apparatus 40 erases the setting of one of the waste cutting lines WCL that are parallel to each other and have a distance between the lines WCL being equal to or smaller than a distance set in advance from among the set waste cutting lines WCL, and forms, between the partial remainder materials PBM, the waste cutting line WCL (WCL1) remaining set.

According to the laser beam machine 1, the control apparatus 40 and the setting method according to the third embodiment, the joint J for coupling either of the part PT that drops off from the supports 11 after the cutting and the part PT that cannot be attracted by the conveying and attracting unit 102 after the cutting to the partial remainder material PBM are formed. Therefore, as with the first and second embodiments, it is possible to convey both of the part PT that drops off from the supports 11 after the cutting and the part PT that cannot be attracted by the conveying and attracting unit 102 after the cutting to the parts storage place 103.

According to the laser beam machine 1, the control apparatus 40 and the setting method according to the third embodiment, some of the waste cutting lines WCL cuts between the partial remainder materials PBM, and thereby the number of the waste cutting lines WCL can be reduced. Therefore, it is possible to reduce a time required for the machining.

### Fourth Embodiment

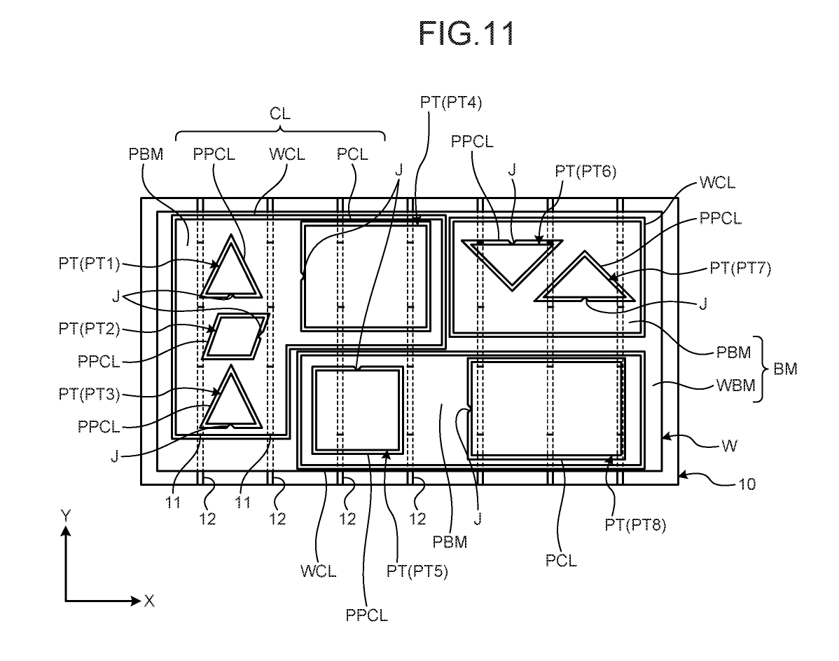

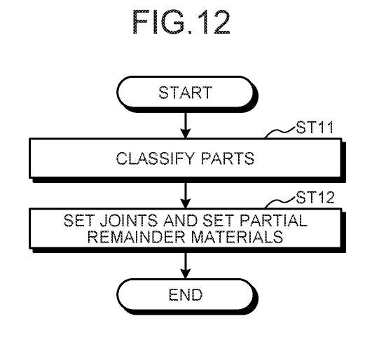

The laser beam machine 1 according to the fourth embodiment of the present invention is explained with reference to the drawings. FIG. 11 is a plan view of a workpiece cut by the laser beam machine according to the fourth embodiment. FIG. 12 is a flowchart showing a setting method according to the fourth embodiment. In FIGS. 11 and 12, elements identical with those in the first embodiment are denoted by the same reference numerals and signs and explanation thereof is omitted.

In the workpiece W cut by the laser beam machine 1 according to the fourth embodiment, as shown in FIG. 11, the parts PT having the same attribute of a post process among the parts PT are coupled to the same partial remainder material PBM. In the fourth embodiment, the attribute of the post process means a process itself of the post process. The process of the post process is a welding process or a painting process. The attribute of the post process may be a product to be assembled. The attribute of the post process is not limited to the process itself of the post process nor the product.

In the setting method according to the fourth embodiment, first, the control apparatus 40 classifies the parts PT by each attributes of the post process (step ST11). The control apparatus 40 sets, for all the parts PT, the joints J corresponding to the respective parts PT, and sets the partial remainder materials PBM and the cutting lines PCL, WCL and PPCL such that the parts PT having the same attribute of the post process among the classified parts PT are coupled to the same partial remainder material PBM (step ST12).

When forming the cutting lines CL on the workpiece W, the control apparatus 40 of the laser beam machine 1 according to the fourth embodiment forms the joints J corresponding to the respective parts PT, and couples the parts PT having the same attribute of the post process among the parts PT to the same partial remainder material PBM. In the fourth embodiment, the first part PT1, the second part PT2, the third part PT3 and the fourth part PT4 are coupled to the same partial remainder material PBM. In the fourth embodiment, the fifth part PT5 and the eighth part PT8 are coupled to the same partial remainder material PBM. In the fourth embodiment, the sixth part PT6 and the seventh part PT7 are coupled to the same partial remainder material PBM.

According to the laser beam machine 1, the control apparatus 40 and the setting method according to the fourth embodiment, the joint J for coupling either of the part PT that drops off from the supports 11 after the cutting and the part PT that cannot be attracted by the conveying and attracting unit 102 after the cutting to the partial remainder material PBM are formed. Therefore, as with the first embodiment, it is possible to convey both of the part PT that drops off from the supports 11 after the cutting and the part PT that cannot be attracted by the conveying and attracting unit 102 after the cutting to the parts storage place 103.

According to the laser beam machine 1, the control apparatus 40 and the setting method of the fourth embodiment, the joints J are formed in all the parts PT and the parts PT having the same attribute of the post process are coupled to the same partial remainder material PBM. Therefore, it is possible to convey the parts PT according to the attribute of the post process.

### Fifth Embodiment

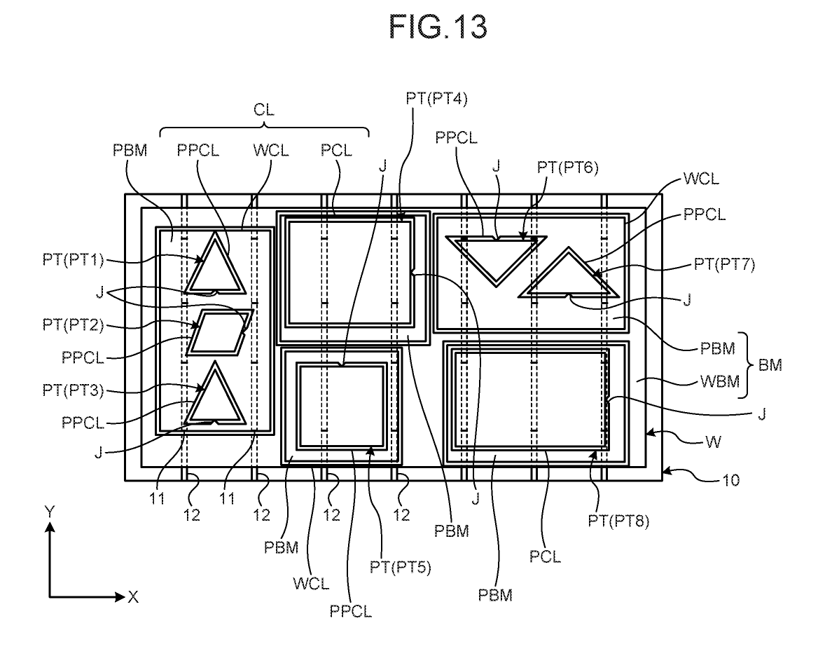

The laser beam machine 1 according to a fifth embodiment of the present invention is explained with reference to the drawings. FIG. 13 is a plan view of a workpiece cut by the laser beam machine according to the fifth embodiment. In FIG. 13, elements identical with those in the first embodiment are denoted by the same reference numerals and signs and explanation thereof is omitted.

The workpiece W cut by the laser beam machine 1 according to the fifth embodiment is the same as the workpiece W in the first embodiment except that all the parts PT are coupled to the partial remainder materials PBM via the joints J, as shown in FIG. 13.

According to the laser beam machine 1, the control apparatus 40 and the setting method according to the fifth embodiment, the joint J for coupling either of the part PT that drops off from the supports 11 after the cutting and the part PT that cannot be attracted by the conveying and attracting unit 102 after the cutting to the partial remainder material PBM are formed. Therefore, as with the first embodiment, it is possible to convey both of the part PT that drops off from the supports 11 after the cutting and the part PT that cannot be attracted by the conveying and attracting unit 102 after the cutting to the parts storage place 103.

According to the laser beam machine 1, the control apparatus 40 and the setting method according to the fifth embodiment, all the parts PT are coupled to the partial remainder materials PBM via the joints J. Therefore, even if the thickness of the workpiece W is smaller than a value set in advance, it is possible to avoid the parts PT from overlapping during the movement by the inter-apparatus moving unit 3. The value set in advance means the thickness of the workpiece W for which the parts PT overlap during the movement by the inter-apparatus moving unit 3. As a result, according to the laser beam machine 1, the control apparatus 40 and the setting method of the fifth embodiment, it is possible to convey the parts PT to the parts storage place 103.

In the above explanation, in the present invention, cutting the workpiece W into a number of parts PT and the remainder material BM by the laser beam machine 1 means cutting the entire outer edges of the parts PT from the remainder material BM and separating the parts PT from the remainder material BM. Further, in the present invention, cutting the workpiece W into a number of parts PT and the remainder material BM by the laser beam machine 1 includes forming one or more joints J in a portion of the outer edge of the part PT and coupling, with the joints J, the parts PT to the partial remainder materials PBM separated from the waste remainder material WBM.

The configurations explained in the embodiments represent examples of the contents of the present invention and can be combined with other publicly-known technologies, and a part of the configuration can be omitted or modified within a range not departing from the spirit of the present invention.

### REFERENCE SIGNS LIST

1 laser beam machine

10 workpiece supporting unit

11 support

20 machining head

30 relative movement unit

40 control apparatus (control unit, setting apparatus, computer)

43 determining unit

44 cutting-position setting unit

100 sorting apparatus

200 machining facility

W workpiece

WE outer edge

CL cutting line

WCL waste cutting line

PT, PT1, PT2, PT3, PT4, PT5, PT6, PT7, PT8 component part

L laser beam

BM remainder material

PBM partial remainder material

WBM waste remainder material

J joint

PG1 program

ST1 determining step

ST2 cutting-position setting step

1. A laser beam machine for cutting a workpiece into a plurality of parts and a remainder material, the laser beam machine comprising:
a workpiece supporting unit including a plurality of supports that are arranged at intervals and support the workpiece;
a machining head to radiate a laser beam to the workpiece;
a relative movement unit to relatively move the machining head and the workpiece supporting unit; and
a control unit to control the relative movement unit and the machining head to cut the workpiece, wherein
the control unit makes control to form, when cutting the workpiece, joints for coupling, to partial remainder materials that are portions of the remainder material, at least both of a part that drops off from the supports after the cutting and a part that cannot be attracted by a conveying and attracting unit after the cutting among the parts, and cut the partial remainder material such that the partial remainder material and the parts coupled to the partial remainder material are restricted from dropping off from the supports and can be attracted by the conveying and attracting unit.

2. The laser beam machine according to claim 1, wherein, when cutting the workpiece, the control unit makes control to form a waste cutting line for cutting between the partial remainder material and a waste remainder material cut from both of all of the parts and the partial remainder material, with reaching an outer edge of the workpiece.

3. The laser beam machine according to claim 1, wherein, when cutting the workpiece, the control unit makes control to form a partial waste cutting line for cutting between the partial remainder materials and a waste remainder material cut from both of all of the parts and the partial remainder material, between the partial remainder materials.

4. The laser beam machine according to claim 1, wherein, when forming cutting lines on the workpiece, the control unit makes control to form the joints respectively corresponding to the parts, and couple parts having the same attribute of a post process among the parts to the same partial remainder material.

5. A machining facility comprising:
the laser beam machine according to claim 1; and
a sorting apparatus that sorts the parts from the workpiece cut by the laser beam machine.

6. A setting apparatus that sets positions of cutting lines for cutting a workpiece into a plurality of parts and a remainder material, the setting apparatus comprising:
a determining unit to determine whether each of the parts is one of a part that drops off from supports of a laser beam machine after cutting and a part that cannot be attracted by a conveying and attracting unit after the cutting; and
a cutting-position setting unit to make setting to form a joint for coupling either of a part that drops off from the supports after the cutting and a part that cannot be attracted by the conveying and attracting unit after the cutting to a partial remainder material that is a portion of the remainder material, and set the positions of the cutting lines such that the partial remainder material and the part coupled to the partial remainder material are restricted from dropping off from the supports and can be attracted by the conveying and attracting unit.

7. A memory medium for storing a program for setting positions of cutting lines for cutting a workpiece into a plurality of parts and a remainder material, the program causing a computer to execute:
a determining step of determining whether each of the parts is one of a part that drops off from supports of a laser beam machine after cutting and a part that cannot be attracted by a conveying and attracting unit after the cutting; and
a cutting-position setting step of forming a joint for coupling either of the part that drops off from the supports after the cutting and the part that cannot be attracted by the conveying and attracting unit after the cutting to a partial remainder material that is a portion of the remainder material, and setting the positions of the cutting lines such that the partial remainder material and the part coupled to the partial remainder material are restricted from dropping off from the supports and can be attracted by the conveying and attracting unit.

8. A setting method for setting positions of cutting lines for cutting a workpiece into a plurality of parts and a remainder material, the setting method comprising:
a determining step of determining whether each of the parts is one of a part that drops off from supports of a laser beam machine after cutting and a part that cannot be attracted by a conveying and attracting unit after the cutting; and
a cutting-position setting step of forming a joint for coupling either of the part that drops off from the supports after the cutting and the part that cannot be attracted by the conveying and attracting unit after the cutting to a partial remainder material that is a portion of the remainder material, and setting the positions of the cutting lines such that the partial remainder material and the part coupled to the partial remainder material are restricted from dropping off from the supports and can be attracted by the conveying and attracting unit.
